(19) United States
(12) Patent Application Publication
(10) Pub. No.: US 2012/0012675 A1
(43) Pub. Date: Jan. 19, 2012

(54) ENCLOSURE FOR A PRESSURIZED SPRAY CONTAINER

(75) Inventor: David Lopez-Bonet, Paris (FR)

(73) Assignee: COTY S.A.S., Paris (FR)

(21) Appl. No.: 12/162,928

(22) PCT Filed: Feb. 2, 2007
(86) PCT No.: PCT/US2007/002849

§ 371 Date: Apr. 30, 2009

Related U.S. Application Data
(60) Provisional application No. 60/743,218, filed on Feb. 2, 2006.

(51) Int. Cl. B05B 11/00

(52) U.S. Cl. 239/302

(57) ABSTRACT

One embodiment of the invention described herein includes a device for dispensing fluid. The device includes a container and a fluid dispensing mechanism, wherein the fluid dispensing mechanism comprises: a main body comprising a deformable portion; a rigid portion annular to the deformable portion; an rigid sidewall, wherein the deformable portion, rigid annular portion and rigid sidewall enclose a mechanism for delivering fluid from the container to a user.

Embodiments of the invention described herein relate to an enclosure for a pressurized spray container.

### COPYRIGHT

A portion of the disclosure of this patent document contains material to which the claim of copyright protection is made. The copyright owner has no objection to the facsimile reproduction by any person of the patent document or the patent disclosure, as it appears in the U.S. Patent and Trademark Office file or records, but reserves all other rights whatsoever. Copyright 2006, 2007 Coty Inc.

### DESCRIPTION OF THE DRAWINGS

FIG. 1 illustrates a perspective view of an overcap embodiment of the invention.

FIG. 2 illustrates a perspective view of an overcap and container assembly of the invention.

FIG. 3 illustrates an internal view of an overcap embodiment of the invention.

FIG. 4 illustrates another perspective view of an overcap embodiment of the invention.

### DESCRIPTION

In the following detailed description of example embodiments of the invention, reference is made to specific examples by way of drawings and illustrations. These examples are described in sufficient detail to enable those skilled in the art to practice the invention, and serve to illustrate how the invention may be applied to various purposes or embodiments. Other embodiments of the invention exist and are within the scope of the invention, and logical, mechanical, chemical, and other changes may be made without departing from the subject or scope of the present invention. Features or limitations of various embodiments of the invention described herein, however essential to the example embodiments in which they are incorporated, do not limit the invention as a whole, and any reference to the invention, its elements, operation, and application do not limit the invention as a whole but serve only to define these example embodiments. The following detailed description does not, therefore, limit the scope of the invention, which is defined only by the appended claims.

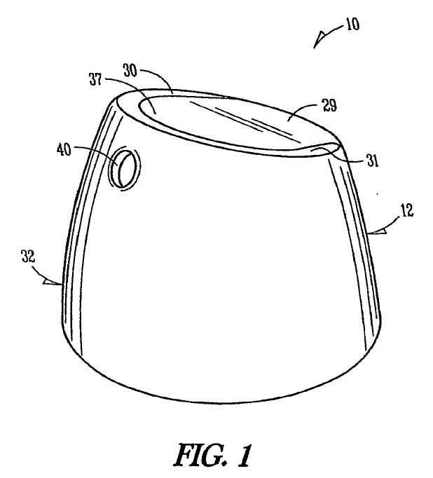

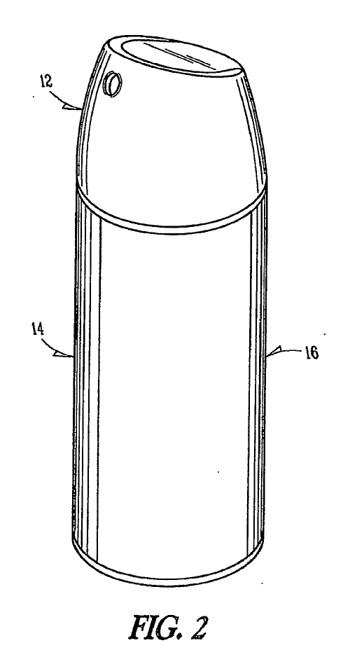

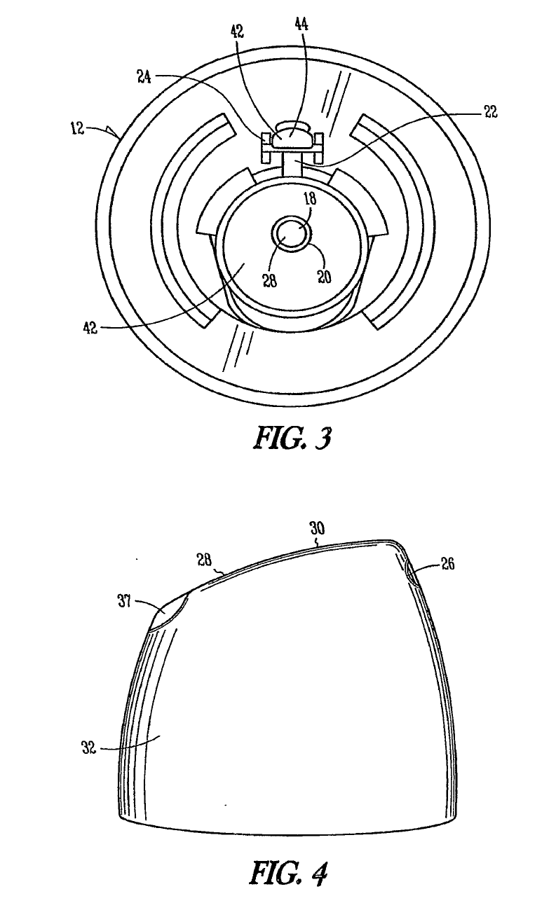

Embodiments of the invention, one of which is shown at 10 in FIG. 1, include an over-cap 12 adapted to be associated with a pressurized dispenser. The pressurized dispenser 14 includes a container 16 upon which is mounted a manually operable dispensing valve 18 provided with a valve stem 20. The valve stem 20 is actuated by a valve operating member 22, shown in an interior view of FIG. 3. The valve stem, when actuated, causes a discharge of material from the container through the over-cap 12.

The over-cap 12 embodiments of the invention are of the type wherein the valve operating member 22 includes a valve stem 24 and has a connection with respect to an internal channel 28 of the over-cap that attaches to the valve stem 24. The pivotal connection includes an actuation surface 26 that is accessible by a deformable portion 29 of a top wall 30.

The over-cap embodiment 12 described herein includes the top wall 30 with the deformable portion 29 and the substantially rigid portion 30 that circumvents the deformable portion 29. The overcap 12 also includes the annular sidewall 32. The top wall 30 extends downwardly at an angle. The annular sidewall 32 meets the top wall 30 so as to form a varying height for the annular sidewall 32. The deformable portion 29 of the top wall 30 covers all but a peripheral area 31 of the top wall. For some embodiments, the peripheral area 31 is substantially rigid. In one embodiment, the deformation portion 29 of the top wall 30 extends into the annular sidewall at 37. The deformable portion 29 of the top wall 30 and annular sidewall at 37 are, for some embodiments, made of a soft memory membrane. The soft memory membrane is an elastomer and is capable of returning to an undeformed state after being deformed from many cycles of use.

The over-cap 10 is also provided with an opening 40 in which a valve operating tab 42, shown in FIG. 3 is pivotally mounted. This opening 40 is located within the rigid annular sidewall 32 of the overcap 10.

Over-cap embodiments described herein provide easy and convenient access of a person's finger to the deformable top wall 29 or a deformable portion of the sidewall 37 when the container 16 is held in the hand of a user and it is desired to dispense material from the container 16.

For one embodiment, when a user presses the deformable portion 29 of the top wall 30, the downward force is propagated over the deformable top wall to an inner wall 42, shown in FIG. 3. The inner wall 42 is also moved downward. This causes a valve associated with the valve stem 24 to open. When the valve opens, liquid from a dispenser 44 is dispensed. It is contemplated that the overcap 10 is usable with other mechanisms that propagate force from a user's finger to a liquid dispenser.

For some embodiments, the overcap 10 is used to dispense antiperspirant. Other embodiments have use in dispensing shaving and moisturizing formulations, shampoos and conditioners, in addition to washes and moisturizers. The overcap 10 embodiments have a wide number of other dispensing applications such as dispensing personal care fluids, home care fluids, industrial and institutional fluids, pharmaceutical fluids, textile fluids, and the like.

Examples of various personal care fluids that can be dispensed by the overcap 10 include products such as the following: Shampoos, for example Baby Shampoos; Conditioning Shampoos; Bodifying Shampoos; Moisturizing Shampoos; Temporary Hair Color Shampoos; 3-in-1 Shampoos; Anti-Dandruff Shampoos; Hair Color Maintenance Shampoos; Acid (Neutralizing) Shampoos; Salicylic Acid Shampoos; Skin and Body Cleansers, for example Moisturizing Body Washes; Antibacterial Body Washes; Deodorizing Body Washes; Bath Gels; Shower Gels; Hand Soaps; Bar Soaps; Body Scrubs; Bubble Baths; Facial Scrubs; Foot Scrubs; Creams and Lotions, for example Alpha-Hydroxy Acid Lotions and Creams; Beta-Hydroxy Acid Creams and Lotions; Skin Whiteners; Self Tanning I Lotions; Sunscreen Lotions; Barrier Lotions; Moisturizers; Hair Styling Creams; Vitamin C Creams; Liquid Talc Products and Antibacterial Lotions; and other moisturizing lotions and creams; Skin and Hair Gels, for example Facial Masks; Body Masks; Hydroalcoholic Gels; Hair Gels; Body Gels; Sunscreen Gels; and the like, as well as other personal care applications such as permanent hair color, and the like.

Examples of home care fluids that can be dispensed using the overcap 10 include fluids such as home care and industrial and institutional fluids, such as laundry detergents; dishwashing detergents (automatic and manual); hard surface cleaners; hand soaps, cleaners and sanitizers; polishes (shoe, furniture, metal, etc.); automotive waxes, polishes, protestants, and cleaners, and the like.

Examples of pharmaceutical fluids that can be dispensed by the overcap 10 include topical formulations in the form of creams, lotions, ointments, or gels, wherein the formulation may be used as a carrier for the pharmaceutically active material, or as a carrier for a skin penetration enhancer, or as a carrier for a phase having an aesthetic effect, or present to enhance the solubility or bioavailability of the pharmaceutically I active material.

The overcap embodiment 10 also stabilizes the container 14 and pressurized contents within the container during transport.

Other features of embodiments of the invention, other than those adverted to, will be apparent from the hereinafter detailed description and appended claims, when read in conjunction with the accompanying drawings.

The accompanying drawings illustrate one practical embodiment of the invention, but the construction therein shown is to be understood is illustrative, only, and not as defining the limits of the invention.

What is claimed is:

1. A device for spraying, comprising:
A container and a spray mechanism, wherein the spray mechanism comprises:
A main body comprising a deformable portion;
A rigid portion annular to the deformable portion; and
An rigid sidewall, wherein the deformable portion, rigid annular portion and rigid sidewall enclose a mechanism for delivering material from the container to a user.

2. The device of claim 1, wherein the deformable portion comprises an elastomer.

3. The device of claim 1, wherein the deformable portion is positioned at the top of the overcap and extends to a sidewall of the overcap.

4. The device of claim 1, wherein the rigid portion annular to the deformable portion defines an orifice for delivering a spray from the device.

5. The device of claim 1 wherein the deformable portion is of an area effective for receiving force from a user's finger.

6. The device of claim 1, further comprising a personal care fluid enclosed by the container.

7. The device of claim 6, wherein the personal care fluid is an antiperspirant.

8. The device of claim 1, further comprising a pharmaceutical fluid enclosed by the container.

9. A device for dispensing fluid, comprising:
A container and a fluid dispensing mechanism, wherein the fluid dispensing mechanism comprising:
A main body comprising a deformable portion;
A rigid portion annular to the deformable portion; and
An rigid sidewall, wherein the deformable portion, rigid annular portion and rigid sidewall enclose a mechanism for delivering fluid from the container to a user.

10. The device of claim 9, wherein the deformable portion comprises an elastomer.

11. The device of claim 9, wherein the deformable portion is positioned at the top of the overcap and extends to a sidewall of the overcap.

12. The device of claim 9, wherein the rigid portion annular to the deformable portion defines an orifice for delivering a spray from the device.

13. The device of claim 9 wherein the deformable portion is of an area effective for receiving force from a user's finger.

14. The device of claim 9, further comprising a personal care fluid enclosed by the container.

15. The device of claim 14, wherein the personal care fluid is an antiperspirant.

16. The device of claim 9, further comprising a pharmaceutical fluid enclosed by the container.

17. A method for delivering fluid from a fluid dispenser, comprising:
Applying a deformable portion comprising an elastomer to the fluid dispenser effective for a user contacting the deformable portion to spray fluid from the dispenser.

18. The method of claim 17 wherein the user contacts the deformable portion anywhere in order to dispense fluid from the dispenser.

19. The method of claim 17, wherein the deformable portion is positioned on an overcap of the spray dispenser.

20. The method of claim 19, wherein deformable portion is positioned at the top of the overcap and extends to a sidewall of the overcap.
